(19) United States
(12) Patent Application Publication
(10) Pub. No.: US 2008/0057313 A1
(43) Pub. Date: Mar. 6, 2008

(54) Thermoset Cross-Linked Polymeric Compositions And Method Of Manufacture

(76) Inventors: Sirarpi Bicakci-Jenkins, San Diego, CA (US); Abboud L. Mamish, Marlborough, MA (US)

Correspondence Address: RAYMOND R. MOSER JR., ESQ.;MOSER IP LAW GROUP, 1030 BROAD STREET, 2ND FLOOR, SHREWSBURY, NJ, 07702, US

(21) Appl. No.: 11/469,787

(22) Filed: Sep. 1, 2006

(51) Int. Cl. B32B 27/12; B32B 27/38; B32B 27/32; C08L 23/04

(52) U.S. Cl. 428/413; 428/523; 442/290; 428/910; 525/240; 525/192

(57) ABSTRACT

Embodiments of the present invention include a heat-shrinkable article, comprising a thermoset cross-linked polymeric composition, wherein the cross-linked polymeric composition comprises at least one polypropylene polymer, and at least one polyethylene polymer, wherein the composition has a polypropylene content of less than about 50 percent by weight, and a polyethylene content of less than about 50 percent by weight, based on the total weight of the cross-linked polymeric composition. A method for making the heat-shrinkable article comprises melt mixing the at least one polypropylene polymer with the at least one polyethylene polymer and at least one additional ingredient, extruding the composition blend to form an extruded material, cross-linking the extruded material to produce a thermoset cross-linked material, stretching the cross-linked material at a temperature at or above a melting point of the material, and cooling the stretched material to maintain a form of the stretched material.

### BACKGROUND

1. Field of the Invention

Embodiments of the present invention generally relate to heat-shrinkable polymeric compositions and methods of making these compositions, and more specifically, to thermoset cross-linked polymeric compositions and methods of manufacture.

2. Description of the Related Art

Heat-shrinkable articles are well known as articles whose dimensional configuration may be made to change when subjected to an appropriate amount of heat. Typically, heat-shrinkable articles comprise tubing, sheets, sleeves, and other molded shapes made from a polymeric material, such as polyethylene. Alternately, some heat-shrinkable articles comprise woven fabrics in conjunction with a polymeric matrix formed by applying a polymeric material to one or both sides of the woven fabric to render the article impermeable to moisture.

Commonly, heat-shrinkable articles are made predominantly of polyethylene, which imparts preferred characteristics to such articles including better conformability over articles made primarily of other polyolefins. For example, heat-shrinkable sleeves used for the corrosion protection of high temperature pipeline joints typically are made with more than 50 percent by weight of polyethylene to impart conformability and integrity at the operating temperature of the pipeline.

Drawbacks associated with polyethylene-predominated heat-shrinkable articles include lack of rigidity and stability at high operating temperatures, such as temperatures greater than 120 degrees Celsius.

Other heat-shrinkable articles are made predominantly of polypropylene, which overcomes the drawbacks associated with using a predominant amount of polyethylene. Polypropylene imparts characteristics including high rigidity and toughness sustained at high operating temperatures. However, heat-shrinkable articles made predominantly of polypropylene lack conformability and property retention, such as, for example, tensile elongation, after exposure for long duration at elevated temperatures, such as, for example, 140 degrees Celsius and above.

Thus, it is desired to have a heat-shrinkable article with improved thermal stability during operating temperatures above ambient conditions but maintains conformability during application of the article.

### SUMMARY

An embodiment of the present invention includes a heat-shrinkable article, comprising a thermoset cross-linked polymeric composition, wherein the cross-linked polymeric composition comprises at least one polypropylene polymer, and at least one polyethylene polymer, wherein the composition has a polypropylene content of less than about 50 percent by weight, and a polyethylene content of less than about 50 percent by weight, based on the total weight of the cross-linked polymeric composition.

Another embodiment of the present invention includes a process for making the heat-shrinkable article of the above embodiment, wherein the process comprises creating a composition blend by melt mixing the at least one polypropylene polymer with the at least one polyethylene polymer and at least one additional ingredient, extruding the composition blend to form an extruded material, cross-linking the extruded material to produce a thermoset cross-linked material, stretching the cross-linked material at a temperature at or above a melting point of the material, and cooling the stretched material to maintain a stretched form. An aspect of this embodiment includes cross-linking by exposing the extruded material to a radiation dosage of about 5 megarads to about 9 megarads using electron-beam irradiation.

### DETAILED DESCRIPTION

Embodiments of the present invention are directed to thermoset cross-linked polymeric compositions that comprise less than about 50 percent by weight of a polypropylene polymer and less than about 50 percent by weight of a polyethylene polymer, and heat-shrinkable articles made from these compositions where the heat-shrinkable articles exhibit improved stability and conformity over cross-linked polymeric compositions predominated by polypropylene, such that the heat-shrinkable articles described in the embodiments herein maintain stability at a temperature from about minus thirty (−30) degrees to about 140 degrees Celsius. In another embodiment, the heat-shrinkable articles described in the embodiments herein maintain stability at a temperature from about 70 degrees Celsius to about 120 degrees Celsius.

An embodiment of the present invention comprises a thermoset cross-linked polymeric composition including at least one polypropylene polymer, at least one polyethylene polymer, and at least one other ingredient, wherein the polypropylene comprises less than about 50 percent by weight and the polyethylene comprises less than about 50 percent by weight of the total composition weight. The polypropylene polymer may be a polypropylene homopolymer, a polypropylene copolymer, a functionalized polypropylene copolymer, or combination thereof. Another embodiment includes a polypropylene polymer in an amount between about 30 percent to about 50 percent by weight of the total composition weight.

A polyethylene polymer may be selected from linear low density polyethylene polymers, low density polyethylene polymers, medium density polyethylene polymers, high density polyethylene polymers, and high molecular weight high density polyethylene polymers, or combinations thereof. In an embodiment of the present invention, a thermoset cross-linked polymeric composition comprises about 15 to about 40 percent by weight of a polyethylene polymer. Another embodiment of the present invention includes a thermoset cross-linked polymeric composition comprising about 21.5 percent by weight of a polyethylene polymer of the total composition weight.

Embodiments of the present invention include a thermoset cross-linked polymeric composition comprising melt mixing the polypropylene polymer with the polyethylene polymer and at least one other ingredient selected from synthetic elastomers, cross-linking promoters, stabilizers, and inorganic fillers.

A synthetic elastomer may be selected from low viscosity semicrystalline grade elastomers and thermoplastic elastomer rubbers. In an embodiment of the present invention, a synthetic elastomer comprises about 15 to about 35 percent by weight of the total composition weight of a thermoset cross-linked polymeric composition. In another embodiment, a synthetic elastomer comprises about 23 percent of the total composition weight of a thermoset cross-linked polymeric composition. The synthetic elastomer imparts flexibility to the resulting heat-shrinkable article during application.

A cross-linking promoter may be selected from multifunctional acrylate monomers or methacrylate monomers typically used as cross-linking promoters for polyolefin-based polymers. Examples of cross-linking promoters include trimethylol propane triacrylate, tetramethylol tetraacrylate, trimethylol propane trimethacrylate, hexanediol diacrylate, and any combination thereof.

In an embodiment of the present invention, a cross-linking promoter comprises about 1 percent to about 3 percent by weight of the total composition weight of a thermoset cross-linked polymeric composition. In another embodiment, a cross-linking promoter comprises about 2.5 percent by weight of the total composition weight of a thermoset cross-linked polymeric composition. The cross-linking promoter facilitates cross-linking of the polymeric composition when using electron beam irradiation or gamma radiation processes such that the desired level of cross-linking is achieved using less radiation dosage and energy than if a cross-linking promoter is not used. In another embodiment, the cross-linking promoter is one or more peroxide cross-linking agents that facilitate cross-linking the polymeric composition when heat is applied. In yet another embodiment, a cross-linking promoter is not added to the polymeric composition as the polymeric composition by itself is sufficiently sensitive to irradiation to achieve the required degree of cross-linking.

A stabilizer may be selected from any suitable primary antioxidant or secondary antioxidant, or a blend of primary and secondary antioxidants. The desired stabilizer is selected to prevent degradation of the thermoset cross-linked polymeric composition during processing and subsequent heat aging of a heat-shrinkable article made from the thermoset cross-linked polymeric composition. Examples of suitable primary antioxidants include hindered amine antioxidants, such as p-Phenylene diamine, trimethyl dihydroquinolines, and alkylated diphenyl amines. Suitable primary antioxidants also may include hindered phenolic antioxidants, such as butylated hydroxytoluene. Examples of suitable secondary antioxidants include trivalent phosphorous antioxidants and divalent sulfur-containing compounds such as sulfides, thiodipropionates and organophosphites.

In an embodiment of the present invention, a stabilizer comprises about 1 percent to about 3 percent by weight of the total composition weight of a thermoset cross-linked polymeric composition. In another embodiment, a stabilizer comprises about 1.5 percent by weight of the total composition weight of a thermoset cross-linked polymeric composition.

One or more inorganic fillers may be selected from glass flakes, clays, and nanoparticles, such as carbon blacks and other nanoclays, and any combination thereof. The inorganic filler imparts rigidity to a product made from a thermoset cross-linked polymeric composition that is typically present when polypropylene is predominant in the composition. In another embodiment of the present invention, an inorganic filler may provide impermeability to moisture in a product made from the thermoset cross-linked polymeric composition.

In an embodiment of the present invention, an inorganic filler comprises about 2 percent to about 10 percent by weight of the total composition weight of a thermoset cross-linked polymeric composition. In another embodiment, an inorganic filler comprises about 1.5 percent by weight of the total composition weight of a thermoset cross-linked polymeric composition.

An embodiment of the present invention comprises a thermoset cross-linked polymeric composition including about 30 to about 50 percent by weight of a polypropylene polymer, about 15 to about 40 percent by weight of a polyethylene polymer, about 15 to about 35 percent by weight of a synthetic elastomer, about 1 to about 3 percent by weight of a cross-linking promoter, about 1 to about 3 percent by weight of a stabilizer, and about 1 to about 10 percent by weight of an inorganic filler.

An embodiment for cross-linking the polymeric composition includes melt mixing the polypropylene polymer, the polyethylene polymer, and at least one other additional ingredient, such as a synthetic elastomer, a cross-linking promoter, a stabilizer, or an inorganic filler. Melt-mixing may occur using machinery, such as, for example, a kneader, a continuous twin-screw compounder, an internal batch mixer, and the like.

The mixed composition is extruded to form a material. The extruded material then is cross-linked via electron-beam irradiation at a radiation dosage between about 5 megarads and about 9 megarads using electron-beam machinery, such as an electron beam accelerator, resulting in a thermoset cross-linked composition. The result of the cross-linking process allows the material to maintain functionality at elevated operating temperatures and above the melting points of the individual ingredients of the polymeric composition. The cross-linking process also prevents a resulting heat-shrinkable article from liquefying during the heat-shrinking process as elevated temperatures may be used.

The radiation dosage used during the selected cross-linking process depends upon the final properties of the desired cross-linked article. Too low of a radiation dosage may result in the article having a low degree of cross-linking, poor mechanical toughness, and a tendency to prematurely soften or melt at elevated temperatures. Alternately, too high of a radiation dosage may result in degradation of the polymeric composition ingredients with a resultant unacceptable deterioration in mechanical properties. An embodiment for cross-linking a polymeric composition includes exposing the polymeric composition to a radiation dosage of about 6 megarads to about 6.5 megarads.

The cross-linked material then is stretched at a temperature at or above the melting point of the polymeric composition, such as, for example, a temperature of about 175 degrees Celsius, and then quickly cooled to maintain the stretched shape of the desired heat-shrinkable article. Stretching the cross-linked extruded material at such an elevated temperature and immediately cooling the material imparts a “memory” to the material, such that when the resulting heat-shrinkable article is applied using heat in an application, the resulting heat-shrinkable article substantially recovers its pre-stretched dimensions. Typically, a heat-shrinkable article, for example, a piping sleeve, is applied to a pipe using heat to facilitate shrinking of the article to conform to the pipe. Heating the article at or near the melting point of the polymeric composition causes the heat-shrinkable article to soften and shrink, thereby causing the article to revert substantially to its originally extruded or molded dimensions.

Another embodiment of the invention comprises stretching the cross-linked material in a machine-direction to uniaxially orient the material for application. The resulting stretched article may be a film article, a tubing article, a molding article, a wrap-around sheet article, or other heat-shrinkable article.

Another embodiment of the present invention comprises melt-mixing a polymeric composition as described herein, extruding the composition onto one side of a woven fabric, and cross-linking the extruded woven fabric to produce a thermoset cross-linked material, thereby creating a heat-shrinkable article. The use of a woven fabric precludes the steps of stretching the extruded material and then cooling the stretched material, as discussed in other embodiments, due to the presence of oriented fibers in the woven fabric. An example of a woven fabric includes a fabric comprising glass fibers interwoven with highly oriented polyethylene fibers. Another embodiment of the present invention further comprises extruding the mixed composition onto a second side of the woven fabric prior to cross-linking the fabric, to further strengthen the resulting heat-shrinkable article. Another embodiment of the present invention further comprises cross-linking the woven fabric prior to extruding the mixed composition onto either side of the woven fabric, to further strengthen the resulting heat-shrinkable article.

The heat-shrinkable articles comprising a cross-linked polymeric composition as described in the embodiments of the present invention maintain stability at a service temperature of about minus 30 degrees Celsius to about 140 degrees Celsius. Further, the heat-shrinkable articles have improved conformability during application than articles predominantly made from polypropylene. Additional materials may be applied to the heat-shrinkable articles of the present invention, either prior to or after stretching, such as an adhesive for applying the article in operation.

The present invention is further illustrated by the following examples:

### EXAMPLE 1

A polymeric composition includes about 50 percent by weight of a polypropylene polymer (Dow Plastics D114), about 21.5 percent by weight of a linear low density polyethylene (Equistar Chemicals, Tuflin 7066), about 23 percent by weight of a low viscosity semicrystalline grade elastomer (Nordel 4725P), about 2.5 percent of trimethylolpropane triacrylate (Sartomer Company, SR-351), about 1.5 percent by weight of a blend of primary and secondary antioxidants (Uniroyal Chemical Company, Naugard 956), and about 1.5 percent of weight of carbon blacks (Cancarb Ltd., Thermax N-990). All ingredients were blended by melt-mixing and extruded into a sheet material. The extruded sheet material was then cross-linked using electron-beam irradiation with a radiation dosage of 6 megarads, thereby producing a thermoset cross-linked material. The material then was heated to a temperature of about 175 degrees Celsius, and stretched to uniaxially orient the cross-linked sheet material.

The mechanical properties of the resulting sheet material of Example 1 are shown in Table 1 below:

TABLE 1

| Property | Test Method | Test Conditions | Result |
|---|---|---|---|
| Tensile Strength & | ASTM D638 | 23 C., 2″/min | 4966 psi |
| Ultimate Elongation | | | 644% |
| 2% Secant Modulus | ASTM D882 | 23 C., 0.4″/min | 43,681 psi |
| Hot Modulus @ | ASTM D638 | 180 C., 2″/min | 19 psi |
| 100% Elongation | | | |
| Gel Content | ASTM D2765 | Method A | 45% |
| Heat Shock | Internal method | 4 hrs | No dripping, |
| | 225 C., | | No cracking |
| Heat Aging | EN 12068 | 140 C., 70 days | 4861 psi |
| followed | | | (98% Retention) |
| By TS & UE | ASTM D638 | 23 C., 2″/min | 569% |
| | | | (85% Retention) |
| Heat Aging | ASTM D3045 | 150 C., 42 days | 3966 psi |
| followed | | | (80% Retention) |
| By TS & UE | ASTM D638 | 23 C., 2″/min | 483% |
| | | | (75% Retention) |

### EXAMPLE 2

A polymeric composition includes about 50 percent by weight of a polypropylene polymer (Dow Plastics D114), about 21.5 percent by weight of a high density polyethylene (Equistar Chemicals, Alathon L5906), about 23 percent by weight of a low viscosity semicrystalline grade elastomer (Nordel 4725P), about 2.5 percent of trimethylolpropane triacrylate (Sartomer Company, SR-351), about 1.5 percent by weight of a blend of primary and secondary antioxidants (Uniroyal Chemical Company, Naugard 956), and about 1.5 percent of weight of carbon blacks (Cancarb Ltd., Thermax N-990). All ingredients were blended by melt-mixing and extruded into a sheet material. The extruded sheet material was then cross-linked using electron-beam irradiation with a radiation dosage of 6 megarads, thereby producing a thermoset cross-linked material. The material then was heated to a temperature of about 175 degrees Celsius, and stretched to uniaxially orient the sheet material.

The mechanical properties of the resulting sheet material of Example 2 are shown in Table 2 below:

TABLE 2

| Property | Test Method | Test Conditions | Result |
|---|---|---|---|
| Tensile Strength & | ASTM D638 | 23 C., 2″/min | 4161 psi |
| Ultimate Elongation | | | 614% |
| 2% Secant Modulus | ASTM D882 | 23 C., 0.4″/min | 48,679 psi |
| Hot Modulus @ | ASTM D638 | 180 C., 2″/min | 18 psi |
| 100% Elongation | | | |
| Gel Content | ASTM D2765 | Method A | 43% |
| Heat Shock | Internal | 4 hrs | No dripping, |
| | method 225 C., | | No cracking |
| Heat Aging | EN 12068 | 140 C., 25 days | 3983 psi |
| followed | | | (96% Retention) |
| By TS & UE | ASTM D638 | 23 C., 2″/min | 530% |
| | | | (94% Retention) |
| Heat Aging | ASTM D3045 | 150 C., 42 days | 3145 psi |
| followed | | | (76% Retention) |
| By TS & UE | ASTM D638 | 23 C., 2″/min | 331% |
| | | | (54% Retention) |

The cross-linked sheet material, after stretching, may be extrusion laminated or coated with an additional layer of material having different functional properties, such as an adhesive.

### EXAMPLE 3

A heat-shrinkable piping sleeve was made by extruding the composition in Example 1 or 2 into a molded sheet, cross-linking the extruded sheet with electron beam irradiation with a radiation dosage of approximately 6 megarads, heating the cross-linked sheet at a temperature close to or above the melting point of the composition, stretching the heated sheet in a machine direction to uniaxially orient the sheet for application, and then rapidly cooling the sheet to below the melting point while maintaining the sheet in the stretched state.

The cross-linked sleeve, after stretching, may be extrusion laminated or coated with an additional layer of material having different functional properties, such as an adhesive suitable to adhere the sleeve to steel piping. An example of such an adhesive is described in U.S. Pat. No. 6,841,212, entitled “Heat-Recoverable Composition and Article,” which, herein, is incorporated by reference in its entirety. Other embodiments of the present invention include applying a coating of epoxy to the sleeve as an adhesive for affixing the sleeve during application.

Additionally, prior to cooling the sheet below the melting point, the sheet may be embossed with a pattern as described in U.S. Pat. No. 5,660,660, entitled “Heat-Recoverable Article,” and 6,015,600 entitled “Heat-Recoverable Article,” each herein incorporated by reference in its entirety. The embossed pattern is designed to indicate when sufficient heat has been applied to the heat-shrinkable article such that adequate recovery of the original dimensions has been achieved during application.

Table 3 displays the mechanical properties associated with the heat-shrinkable sleeve of Example 3:

TABLE 3

| | | | Backing 1 | Backing 2 | Backing 2 |
|---|---|---|---|---|---|
| Property | Test Method | Test Conditions | Adhesive 1 | Adhesive 1 | Adhesive 2 |
| Peel Strength | ASTM D1000 | 23 C., 2″/min | 38 pli | 75 pli | 53 pli |
| To primer | | 120 C., 2″/min | 14 pli | 13 pli | 11 pli |
| Peel Strength | EN 12068 | 23 C., 10 mm/min | 48 N/cm | 81 N/cm | 82 N/cm |
| To Primer | | 120 C., 10 mm/min | 24 N/cm | 21 N/cm | 20 N/cm |
| Cathodic | ASTM G-42 | 95 C., 30 days | 6.2 mm | not tested | not tested |
| Disbondement | | | | | |
| Penetration | NF A49-711 | 110 C., 1 hr | 3.3 mm | 2.9 mm | 3.3 mm |
| depth | | | | | |
| Holiday detection | | 15 kV | pass | pass | pass |
| Impact | NF A49-711 | 23 C., 15 kV | 9 J | 9 J | 10 J |
| Resistance | | | | | |

While the foregoing is directed to embodiments of the present invention, other and further embodiments of the present invention may be devised without departing from the basic scope thereof.

We claim:

1. A heat-shrinkable article, comprising:
a thermoset cross-linked polymeric composition, the cross-linked polymeric composition comprising:
at least one polypropylene polymer; and
at least one polyethylene polymer;
wherein the composition has a polypropylene content of less than about 50 percent by weight, and a polyethylene content of less than about 50 percent by weight, based on the total weight of the cross-linked polymeric composition.

2. The heat-shrinkable article of claim 1, wherein the at least one polypropylene polymer is selected from the group consisting of polypropylene homopolymers, polypropylene copolymers, and functionalized polypropylene copolymers.

3. The heat-shrinkable article of claim 1, wherein the heat-shrinkable article maintains stability at a service temperature of about minus 30 degrees Celsius to about 140 degrees Celsius.

4. The heat-shrinkable article of claim 1, wherein the heat-shrinkable article maintains stability at a service temperature of about 70 degrees Celsius to about 120 degrees Celsius.

5. The heat-shrinkable article of claim 1, further comprising at least one ingredient selected from the group consisting of synthetic elastomers, cross-linking promoters, stabilizers, and inorganic fillers.

6. The heat-shrinkable article of claim 1, wherein the heat-shrinkable article comprises:
about 30 to about 50 percent by weight of a polypropylene polymer;
about 15 to about 40 percent by weight of a polyethylene polymer;
about 15 to about 35 percent by weight of a synthetic elastomer;
about 1 to about 3 percent by weight of a cross-linking promoter;
about 1 to about 3 percent by weight of a stabilizer; and
about 1 to about 10 percent by weight of an inorganic filler.

7. The heat-shrinkable article of claim 1, wherein the heat-shrinkable article comprises:
about 50 percent by weight of a propylene polymer;
about 21.5 percent by weight of a polyethylene polymer;
about 23 percent by weight of a synthetic elastomer;
about 2.5 percent by weight of a cross-linking promoter;
about 1.5 percent by weight of a stabilizer; and
about 1.5 percent by weight of an inorganic filler.

8. The heat-shrinkable article of claim 6, wherein the polyethylene polymer is selected from the group consisting of linear low density polyethylene, low density polyethylene, medium density polyethylene, high density polyethylene, and high molecular weight high density polyethylene.

9. The heat-shrinkable article of claim 6, wherein the synthetic elastomer is selected from the group consisting of low viscosity semicrystalline grade elastomers and thermoplastic elastomer rubbers.

10. The heat-shrinkable article of claim 6, wherein the cross-linking promoter is selected from the group consisting of multifunctional acrylate monomers and methacrylate monomers.

11. The heat-shrinkable article of claim 10, wherein a multifunctional acrylate monomer or a methacrylate monomer is selected from the group consisting of trimethylol propane triacrylate, tetramethylol tetraacrylate, trimethylol propane trimethacrylate, and hexanediol diacrylate.

12. The heat-shrinkable article of claim 6, wherein the stabilizer is a primary antioxidant, a secondary antioxidant, or a combination thereof.

13. The heat-shrinkable article of claim 12, wherein the primary antioxidant is selected from the group consisting of p-Phenylene diamine, trimethyl dihydroquinolines, alkylated diphenyl amines, and hindered phenolic antioxidants.

14. The heat-shrinkable article of claim 12, wherein the secondary antioxidant is selected from the group consisting of trivalent phosphorous antioxidants and divalent sulfur-containing compounds.

15. The heat-shrinkable article of claim 6, wherein the inorganic filler is selected from a group consisting of carbon blacks, glass flakes, clays, nanoclays, and other nanoparticles.

16. The heat-shrinkable article of claim 1, further comprising an adhesive composition coating.

17. The heat-shrinkable article of claim 1, further comprising an epoxy coating.

18. The heat-shrinkable article of claim 1, wherein the article is formed by a process comprising:
creating a composition blend by melt mixing the at least one polypropylene polymer with the at least one polyethylene polymer and at least one additional ingredient;
extruding the composition blend to form an extruded material;
cross-linking the extruded material to produce a thermoset cross-linked material;
stretching the cross-linked material at a temperature at or above a melting point of the material; and
cooling the stretched material to maintain a stretched form.

19. The heat-shrinkable article of claim 18, further comprising stretching the material in a machine direction to uniaxially orient the material for application.

20. The heat-shrinkable article of claim 18, further comprising cross-linking the extruded shaped article by exposing the extruded shaped article to electron-beam irradiation.

21. The heat-shrinkable article of claim 19, further comprising exposing the extruded shaped article to a radiation dosage of about 5 megarads to about 9 megarads using electron-beam irradiation.

22. The heat-shrinkable article of claim 19, further comprising exposing the extruded shaped article to a radiation dosage of about 6 megarads to about 6.5 megarads using electron-beam irradiation.

23. The heat-shrinkable article of claim 18, wherein the at least one additional ingredient is selected from the group consisting of synthetic elastomers, cross-linking promoters, stabilizers, and inorganic fillers.

24. The heat-shrinkable article of claim 18, further comprising cross-linking the extruded shaped article using gamma irradiation.

25. The heat-shrinkable article of claim 18, further comprising cross-linking the extruded shaped article using at least one peroxide-cross-linking agent.

26. The heat-shrinkable article of claim 1, wherein the article is formed by a process comprising:
creating a composition blend by melt mixing the at least one polypropylene polymer with the at least one polyethylene polymer and at least one additional ingredient;
extruding the composition blend to form an extruded material;
cross-linking the extruded material by exposing the extruded material to a radiation dosage of about 6 megarads to about 6.5 megarads using electron-beam irradiation to produce a thermoset cross-linked material;
stretching the cross-linked material at a temperature above a melting point of the material; and
cooling the stretched material to maintain a stretched form.

27. The heat-shrinkable article of claim 26, wherein the at least one additional ingredient is selected from the group consisting of synthetic elastomers, cross-linking promoters, stabilizers, and inorganic fillers.

28. The heat-shrinkable article of claim 1, further comprising a woven fabric.

29. The heat-shrinkable article of claim 27, wherein the woven fabric comprises glass fibers interwoven with highly oriented polyethylene fibers.

30. The heat-shrinkable article of claim 27, wherein the article is formed by a process comprising:
creating a composition blend by melt mixing the at least one polypropylene polymer with the at least one polyethylene polymer and at least one additional ingredient;
extruding the composition blend onto the woven fabric to coat a first side of the woven fabric; and
cross-linking the extruded woven fabric to produce a thermoset cross-linked material.

31. The heat-shrinkable article of claim 30, wherein cross-linking the extruded woven fabric further comprises exposing the extruded woven fabric to electron-beam irradiation.

32. The heat-shrinkable article of claim 31, further comprising exposing the extruded woven fabric to a radiation dosage of about 5 megarads to about 9 megarads using electron-beam irradiation.

33. The heat-shrinkable article of claim 31, further comprising exposing the extruded woven fabric to a radiation dosage of about 6 megarads to about 6.5 megarads using electron-beam irradiation.

34. The heat-shrinkable article of claim 30, wherein the at least one additional ingredient is selected from the group consisting of synthetic elastomers, cross-linking promoters, stabilizers, and inorganic fillers.

35. The heat-shrinkable article of claim 30, further comprising extruding the composition blend onto the woven fabric to coat a second side of the woven fabric prior to cross-linking the extruded woven fabric.

36. The heat-shrinkable article of claim 35, further comprising cross-linking the woven fabric prior to extruding the composition blend onto both the first side and the second side of the woven fabric.

37. The heat-shrinkable article of claim 30, further comprising cross-linking the woven fabric prior to extruding the composition blend onto the first side of the woven fabric.

38. The heat-shrinkable article of claim 1, wherein the article is at least one of a fiber article, a film article, a tubing article, a molding article, and a wrap-around sheet article.

39. The heat-shrinkable article of claim 1, wherein the article is a piping sleeve.
